(19) United States
(12) Patent Application Publication
(10) Pub. No.: US 2018/0020479 A1
(43) Pub. Date: Jan. 18, 2018

(54) RADIO BASE STATION, USER TERMINAL AND RADIO COMMUNICATION METHOD

(71) Applicant: NTT DOCOMO, INC., Tokyo (JP)

(72) Inventors: Hiroki HARADA, Tokyo (JP); Satoshi NAGATA, Tokyo (JP); Jing WANG, Beijing (CN); Liu LIU, Beijing (CN); Huiling JIANG, Beijing (CN)

(73) Assignee: NTT DOCOMO, INC., Tokyo (JP)

(21) Appl. No.: 15/544,910

(22) PCT Filed: Jan. 29, 2016
(86) PCT No.: PCT/JP2016/052624

§ 371 Date: Jul. 20, 2017

(30) Foreign Application Priority Data
Jan. 29, 2015 (JP) 2015-016020

(51) Int. Cl. H04W 74/08; H04W 16/14; H04W 24/10; H04W 74/00

(52) U.S. Cl. CPC H04W 74/0808; H04W 74/006; H04W 16/14; H04W 24/10

(57) ABSTRACT

The present invention is designed to optimize the RRM measurements in a carrier where an LBT function is applied. A radio base station executes LBT (Listen Before Talk) in an unlicensed carrier, acquires an LBT result, determines the timing to measure a DRS (Discovery Reference Signal) that is transmitted in the unlicensed carrier, and transmits the LBT result and the measurement timing to a user terminal, and the user terminal receives the LBT result and the DRS measurement timing from the radio base station, and detects the unlicensed carrier by measuring the DRS that is transmitted in the unlicensed carrier based on the LBT result, based on the LBT result and the measurement timing.

### TECHNICAL FIELD

The present invention relates to a radio base station, a user terminal and a radio communication method in a next-generation mobile communication system.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). Also, successor systems of LTE (also referred to as, for example, “LTE-advanced” (hereinafter referred to as “LTE-A”), “FRA” (Future Radio Access) and so on) are under study for the purpose of achieving further broadbandization and increased speed beyond LTE.

Furthermore, in relationship to future radio communication systems (Rel. 13 and later versions), a system (“LTE-U” (LTE Unlicensed)) to run an LTE system not only in frequency bands that are licensed to communications providers (operators) (licensed bands), but also in frequency bands that do not require license (unlicensed bands), is under study.

While a licensed band refers to a band in which a specific operator is allowed exclusive use, an unlicensed band (also referred to as a “non-licensed band”) refers to a band which is not limited to a specific operator and in which radio stations can be provided. For unlicensed bands, for example, the 2.4 GHz band and the 5 GHz band where Wi-Fi and Bluetooth (registered trademark) can be used, and the 60 GHz band where millimeter-wave radars can be used are under study for use.

In LTE-U operation, a mode that is premised upon coordination with licensed band LTE is referred to as “LAA” (Licensed-Assisted Access), “LAA-LTE” and so on. Note that systems that run LTE/LTE-A in unlicensed bands may be collectively referred to as “LAA,” “LTE-U,” “U-LTE” and so on.

For unlicensed bands in which LAA is run, a study is in progress to introduce interference control functionality in order to allow co-presence with other operators' LTE, Wi-Fi or different systems. In Wi-Fi, LBT (Listen Before Talk), which is based on CCA (Clear Channel Assessment), is used as an interference control function within the same frequency. In Japan and Europe, the LBT function is stipulated as mandatory in systems that are run in the 5 GHz unlicensed band such as Wi-Fi.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall description; Stage 2”

### SUMMARY OF INVENTION

### Technical Problem

Now, in Rel-13, there is an agreement to apply RRM (Radio Resource Management) measurement function to unlicensed carriers, in addition to LBT functions. As for the measurement signals to use in RRM measurements for unlicensed carriers, the discovery reference signal (DRS) is under study for use. Since, as noted earlier, LBT is mandatory in unlicensed carriers, DRSs are not transmitted unless an idle channel is detected by LBT. In unlicensed carriers, whether or not DRSs are transmitted depends upon the result of LBT, and therefore there is a need for new communication control that is suitable for RRM measurements in unlicensed carriers.

The present invention has been made in view of the above, and it is therefore an object of the present invention to provide a radio base station, a user terminal and a radio communication method that can optimize RRM measurements in carriers where LBT functions are used.

### Solution to Problem

The radio base station of the present invention allows a user terminal, which uses a first carrier as a primary cell, to detect a second carrier, where an LBT (Listen Before Talk) function is applied, as a secondary cell, and this radio base station has a detection section that executes LBT in the second carrier and acquires an LBT result, a determining section that determines a measurement timing for a measurement signal that is transmitted in the second carrier based on the LBT result, and a transmission section that, when there are the LBT result and the measurement timing, transmits at least the measurement timing to the user terminal.

### Advantageous Effects of Invention

According to the present invention, it is possible to let a user terminal know the channel status of a second carrier and the measurement timings of measurement signals by using LBT results, and allow the user terminal to measure the measurement signals at measurement timings where the channels is idle. By this means, for the measurement signals that are transmitted in the second carrier depending on the result of LBT, it is possible to avoid missing measurements or performing wrong measurements where the measurement signals are not transmitted, so that it is possible to allow a user terminal to measure the measurement signals adequately, and improve the reliability of measurements. By letting a user terminal know the measurement timings of measurement signals, it is possible to reduce the load of measurement processes in the user terminal.

### BRIEF DESCRIPTION OF DRAWINGS

FIG. 1 provide diagrams to show examples of operation modes in radio communication systems in which LTE is used in unlicensed bands;

FIG. 2 is a diagram to explain the signal configuration of the DRS;

FIG. 3 provide diagrams to explain conventional radio communication methods;

FIG. 4 provide diagrams to explain radio communication methods that use the ON/OFF status of secondary cells;

FIG. 5 provide diagrams to explain radio communication methods that use the ON/OFF status of secondary cells;

FIG. 6 provide diagrams to explain first radio communication method that uses LBT results;

FIG. 7 provide diagrams to explain a second radio communication method that uses LBT results;

FIG. 8 provide diagrams to explain a third radio communication method that uses LBT results;

FIG. 9 is a diagram to show a schematic structure of the radio communication system according to the present embodiment.

FIG. 10 is a diagram to show an example of an overall structure of a radio base station according to the present embodiment;

FIG. 11 is a diagram to show an example of a functional structure of a radio base station according to the present embodiment;

FIG. 12 is a diagram to show an example of an overall structure of a user terminal according to the present embodiment; and

FIG. 13 is a diagram to show an example of a functional structure of a user terminal according to the present embodiment.

### DESCRIPTION OF EMBODIMENTS

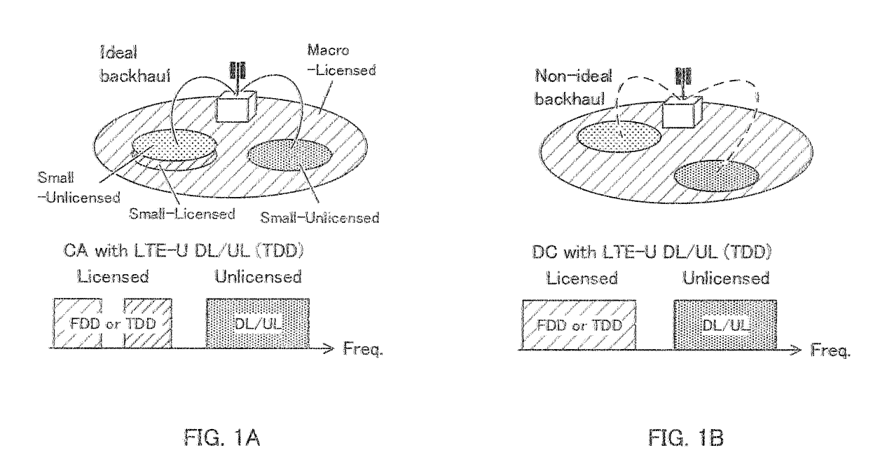

FIG. 1 show operation modes in a radio communication system (LTE-U) in which LTE is run in unlicensed bands. As scenarios to use LTE in unlicensed bands, scenarios to employ carrier aggregation (CA) (see FIG. 1A) and dual connectivity (DC) (see FIG. 1B) are possible. Although not described herein, as another possible scenario to use LTE in unlicensed bands, a scenario to apply stand-alone (SA), in which a cell that runs LTE in unlicensed bands works alone, may be used.

Referring to the example shown in FIG. 1A, carrier aggregation (CA) is applied to the licensed carriers (licensed bands) of the macro cell and/or a small cell and the unlicensed carriers (unlicensed bands) of small cells. CA is a technique to bundle a plurality of frequency blocks (also referred to as “component carriers” (CCs), “carriers,” “cells,” etc.) into a wide band. Each CC has, for example, a maximum 20 MHz bandwidth, so that, when maximum five CCs are bundled, a wide band of maximum 100 MHz is provided. In CA, a single radio base station's scheduler controls the scheduling of a plurality of CCs, and therefore CA may be referred to as “intra-base station CA” (intra-eNB CA).

Also, although FIG. 1A show an example where the unlicensed carriers support both DL/UL, an unlicensed carrier may be used for DL communication only, or may be used for UL communication only. A carrier that is used for DL communication only is also referred to as a “supplemental downlink” (SDL). Note that the licensed carriers of the macro cell and/or a small cell can use FDD and/or TDD.

Furthermore, a (co-located) structure may be employed, in which a licensed carrier and an unlicensed carrier transmit and receive via one transmitting/receiving point (for example, a radio base station). In this case, this transmitting/receiving point (for example, an LTE/LTE-U base station) can communicate with a user terminal by using both the licensed carrier and the unlicensed carrier. Alternatively, it is equally possible to employ a (non-co-located) structure, in which a licensed carrier and an unlicensed carrier transmit and receive via different transmitting/receiving points (for example, one via a radio base station and the other one via an RRH (Remote Radio Head) that is connected with the radio base station).

In the example shown in FIG. 1B, dual connectivity (DC) is applied to the macro cell's licensed carrier and the small cells' unlicensed carriers. DC is the same as CA in bundling a plurality of CCs (or cells) into a wide band. While CA is based on the premise that CCs (or cells) are connected via ideal backhaul and enables coordinated control that produces very little delay time, DC presumes cases in which cells are connected via non-ideal backhaul, which produces delay time that is more than negligible.

Consequently, in DC, cells are run by separate base stations, and user terminals communicate by connecting with cells (or CCs) that are run by different base stations in different frequencies. So, when DC is employed, a plurality of schedulers are provided individually. These multiple schedulers each control the scheduling of one or more cells (CCs) they have control over, and therefore DC may be referred to as “inter-base station CA” (inter-eNB CA). Note that, in DC, carrier aggregation (intra-eNB CA) may be employed per individual scheduler (that is, base station) that is provided.

Also, in DC, an unlicensed carrier needs to be a carrier to support both DL/UL. Note that the macro cell's licensed carrier can use FDD and/or TDD.

In these operation modes, for example, it is possible to use a licensed carrier (macro cell) as the primary cell (PCell) and use an unlicensed carrier (small cell) as a secondary cell (SCell). The primary cell refers to the cell that manages RRC connection, handover and so on, and is also a cell that requires UL communication such as data and feedback signals from user terminals. In the primary cell, the uplink and the downlink are always configured. A secondary cell is another cell that is configured in addition to the primary cell. In a secondary cell, the downlink or the uplink alone may be configured, or both the uplink and the downlink may be configured.

In LTE-U operation, a mode that holds the premise that LTE is used in licensed bands (licensed LTE) is referred to as “LAA” (Licensed-Assisted Access), “LAA-LTE” and so on. Note that systems that run LTE/LTE-A in unlicensed bands may be collectively referred to as “LAA,” “LTE-U,” “U-LTE,” and so on. Now, in Rel-13 LAA, interference cancellation that is based upon LBT (Listen Before Talk) functions for allowing co-presence with other operators' LTE, Wi-Fi or different systems, RRM (Radio Resource Management) measurement functions for allowing adequate connecting cell management, and so on are mandatory in secondary cells.

In an unlicensed carrier in which LBT is configured, radio base stations and user terminals of a plurality of systems use the same frequency bands on a shared basis, and LBT can prevent interference between LAA and Wi-Fi, interference between LAA systems, and so on. Note that, in LBT, “listening” refers to the operation which a transmission point (for example, a radio base station and/or a user terminal) performs before transmitting signals in order to check whether or not signals to exceed a predetermined level (for example, predetermined power) are being transmitted from other transmission points. Also, “listening” may be referred to as “LBT” (Listen Before Talk), “CCA” (Clear Channel Assessment), “carrier sensing,” and so on.

When a transmission point (for example, a radio base station) in an LTE system in which LBT is used detects no signals from other systems (for example, Wi-Fi) and/or other LAA transmission points upon listening (LBT, CCA, etc.), the transmission point communicates in an unlicensed carrier. For example, if received power that is equal to or lower than a predetermined threshold is measured in LBT, the transmission point judges that the channel is in idle status (LBT_idle), and carries out transmission. When a “channel is in idle status,” this means that, in other words, the channel is not occupied by a certain system, and it is equally possible to say that “a channel is idle,” “a channel is clear,” “a channel is free,” and so on.

For example, when the received power that is measured in LBT exceeds a predetermined threshold, the transmission point judges that the channel is in busy status (LBT_busy), and does not carry out transmission. When a channel is in busy status, LBT is carried out again with respect to this channel, and the channel becomes available for use only after it is confirmed that the channel is in idle status. Note that the method of judging whether a channel is in idle status/busy status based on LBT is by no means limited to this.

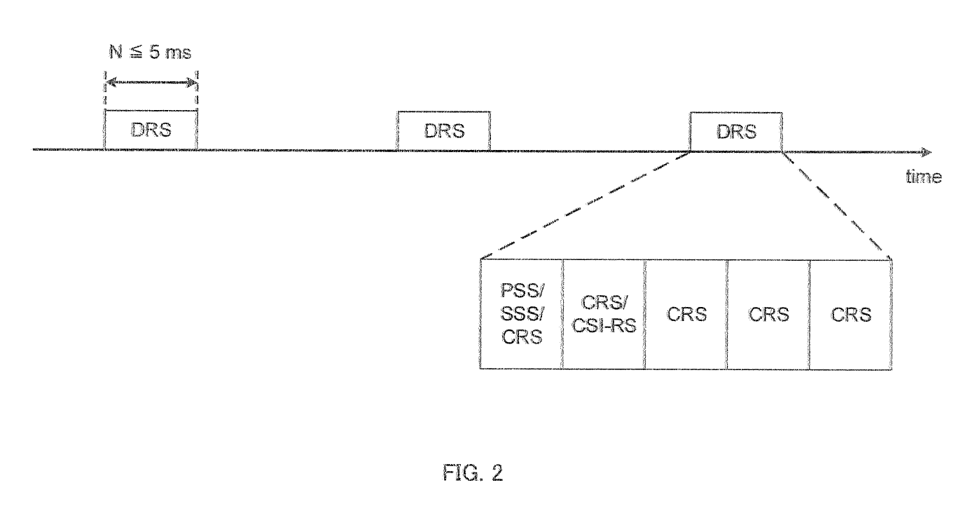

As shown in FIG. 2, for the measurement signal for unlicensed carriers (secondary cells), the discovery reference signal (DRS) of Rel-12 is under study. The DRS can be constituted by a combination of a plurality of signals transmitted in a predetermined period N. The DRS is transmitted in the DwPTS (Downlink Pilot Time Slot) in DL (downlink) subframes or special subframes in TDD (Time Division Duplex). The predetermined period N is, for example, 1 ms (one subframe) to maximum 5 ms (five subframes), but this is by no means limiting.

The DRS can be constituted by a combination of synchronization signals (PSS (Primary Synchronization Signal)/SSS (Secondary Synchronization Signal)) and the CRS (Cell-specific Reference Signal) of existing systems (for example, LTE Rel-11), a combination of synchronization signals (PSS/SSS), the CRS and the CSI-RS (Channel State Information Reference Signal) of existing systems, and so on. For example, the DRS shown in FIG. 2 includes a PSS/SSS/CRS in the first subframe, a CRS/CSI-RS in the second subframe, and CRSs in the third to the fifth subframe. Note that the DRS is not limited to these structures, and may contain new reference signals (including ones that modify conventional reference signals).

For example, the PSS and the SSS included in the DRS are used in an early stage of cell search. To be more specific, the PSS is used to establish symbol timing synchronization and to detect the cell's local identifier. Also, the SSS is used to establish radio frame synchronization and to detect the cell's group identifier. Also, from the PSS and the SSS, it becomes possible to acquire the physical cell ID (PCID: Physical Cell Identifier) of the cell. Note that when DRS-based measurements are configured in a user terminal, it is possible to assume that the DRS measurement period is configured at the same time, and that the PSS/SSS/CRS are included in the DRS measurement period. Also, it is equally possible to assume that each cell's DRS includes the PSS/SSS, one symbol each, in the DRS measurement period. Furthermore, it is also possible to assume that the CRS is transmitted in all DL subframes in the DRS measurement period.

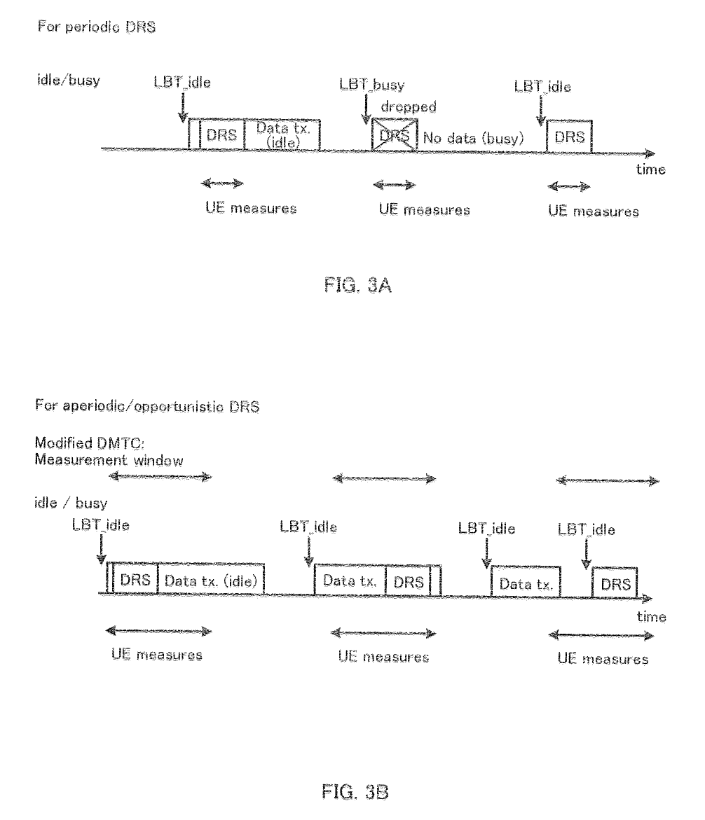

Now, since LBT is mandatory in LAA secondary cells (unlicensed carriers), DRS transmission also needs to follow the results of LBT (LBT-idle/busy). As shown in FIG. 3A, when, in a secondary cell, DRSs are transmitted periodically, a DRS is transmitted if a channel is in idle status, and a DRS is dropped if a channel is in busy status. When DRSs are periodic (periodic DRSs), DMTC (DRS Measurement Timing Configuration) to indicate the periodic DRS measurement timings is reported from the network (radio base station) end to a user terminal through higher layer signaling (RRC signaling). In the DMTC, at least the DRS cycle and a DRS measurement timing offset that is based on the timing of the PCell are included.

The user terminal learns the periodic DRS measurement timings from the DMTC reported from the network, and measures the DRSs that are transmitted periodically in the secondary cell. In this case, the actual timing each reference signal (CRS) is received in a DRS measurement period is detected by using the PSS/SSS in the DRS measurement period. However, although a DRS is dropped when a channel is in busy status, the user terminal nevertheless operates to measure the DRS. In this case, the user terminal is unable to decide whether the DRS is not actually transmitted, or whether the received power of the DRS is simply too low. Consequently, measurement reports are prepared by including measurement results that are acquired when DRSs are not transmitted, and therefore the accuracy of RRM measurement results deteriorates.

Meanwhile, it is worth considering that DRSs are also transmitted aperiodically in a secondary cell, as shown in FIG. 3B. In this case, a DRS is transmitted only when there is a channel that is in idle status, so that no DRS is dropped. When DRSs are aperiodic (aperiodic/opportunistic DRSs), modified DMTC may be used, and a measurement window that is longer than the actual period DRSs are transmitted is configured in a user terminal with modified DMTC. In modified DMTC, for example, at least the cycle of the measurement window and an measurement window configuration timing offset that is based on the timing of the PCell may be included.

Aperiodic DRSs are transmitted somewhere in the above measurement window, so that the user terminal measures the DRSs that are transmitted aperiodically in the secondary cell, by monitoring the measurement window. In this case, the actual timing each reference signal is received in a DRS measurement period is detected by using the PSS/SSS in the DRS measurement period. However, the user terminal has to keep monitoring the measurement window, which is longer than the period DRSs are actually transmitted, and therefore the power consumption in the user terminal increases compared to the above-described case of periodic DRS transmission.

In this way, since both periodic DRSs and aperiodic DRSs lead to damaging the accuracy of DRS measurements by user terminals and increasing the load of the measurement process, it is necessary to let user terminals know the timings of DRS measurements. In this case, in addition to DMTC that indicates periodic DRS measurement timings, a method of letting user terminal know the ON/OFF status of secondary cells (unlicensed carriers) may be possible. As for the method of reporting the ON/OFF status of secondary cells, it is possible to send reports to user terminals by using the primary cell's L1 signaling (DCI: Downlink Control Information), or allow user terminals to execute blind detection.

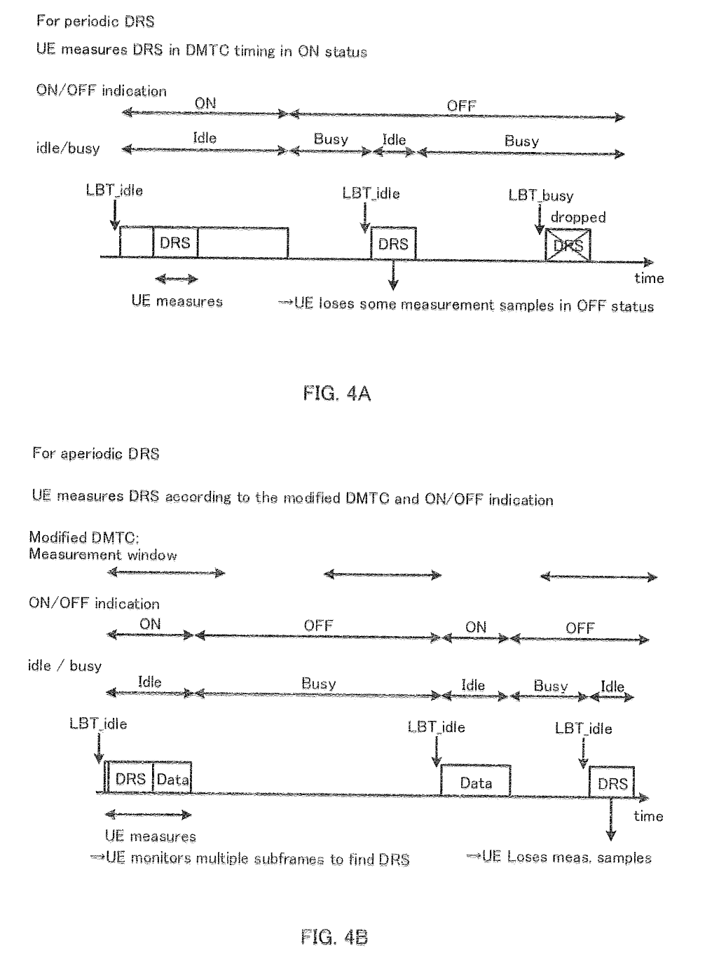

First, a method of reporting the ON/OFF status of a secondary cell (unlicensed carrier) to user terminals by using L1 signaling will be described with reference to FIG. 4. As shown in FIG. 4A, when DRSs are transmitted periodically in a secondary cell, periodic DRS measurement timings are reported to a user terminal by means of DMTC, and the ON/OFF status of the secondary cell is reported by L1 signaling of the primary cell (licensed carrier). In this case, the user terminal may operate to measure the DRSs at periodic measurement timings when the secondary cell is in ON status, and not measure the DRSs when the secondary cell is in OFF status.

Although, in this operation, a DRS is dropped when the channel is in busy status, the secondary cell is in OFF status when the channel is in busy status, and therefore the user terminal does not operate to conduct wrong DRS measurements where no DRSs are transmitted. Now, on the radio base station end, the ON/OFF status of the secondary cell is determined based on whether or not there is data. That is, when the secondary cell is in OFF status, this covers not only the state in which the channel is not idle, but also the state in which there is no data to transmit even though the channel is idle. Consequently, cases occur where the DRS alone is transmitted even though the secondary cell is in OFF status, and, in such cases, the user terminal cannot catch the DRS, resulting in a missing measurement. Consequently, it takes time to fulfill the number of DRS measurements that is required to achieve predetermined reliability of measurements, and, furthermore, the measurement results of part of the DRSs are not mirrored in the reliability of measurements, and there sufficient reliability of measurements cannot be achieved.

Also, as shown in FIG. 4B, assuming that DRSs are transmitted aperiodically in the secondary cell, a measurement window that is longer than the DRS transmission period is configured in the user terminal, and the ON/OFF status of the secondary cell is reported by way of L1 signaling. In this case, the user terminal may operate to monitor the measurement window when the secondary cell is in ON status, and measure DRSs that are transmitted somewhere in the measurement window. Also, the user terminal does not monitor the measurement window when the secondary cell is in OFF status, and does not measure the DRSs transmitted in this measurement window.

In this case, the user terminal monitors the period in which the measurement window and the secondary cell's ON status overlap, so that the load of the user terminal can be reduced compared to the case of monitoring the whole of the measurement window (see FIG. 3B). However, it is still necessary to monitor DRSs longer than the period in which DRSs are actually transmitted, so that the user terminal's power consumption is not reduced to a sufficient level. Also, as mentioned earlier, cases occur where DRSs are transmitted even while the secondary cell is in OFF status, and where, due to missing DRS measurements that occur, sufficient reliability of measurements cannot be achieved.

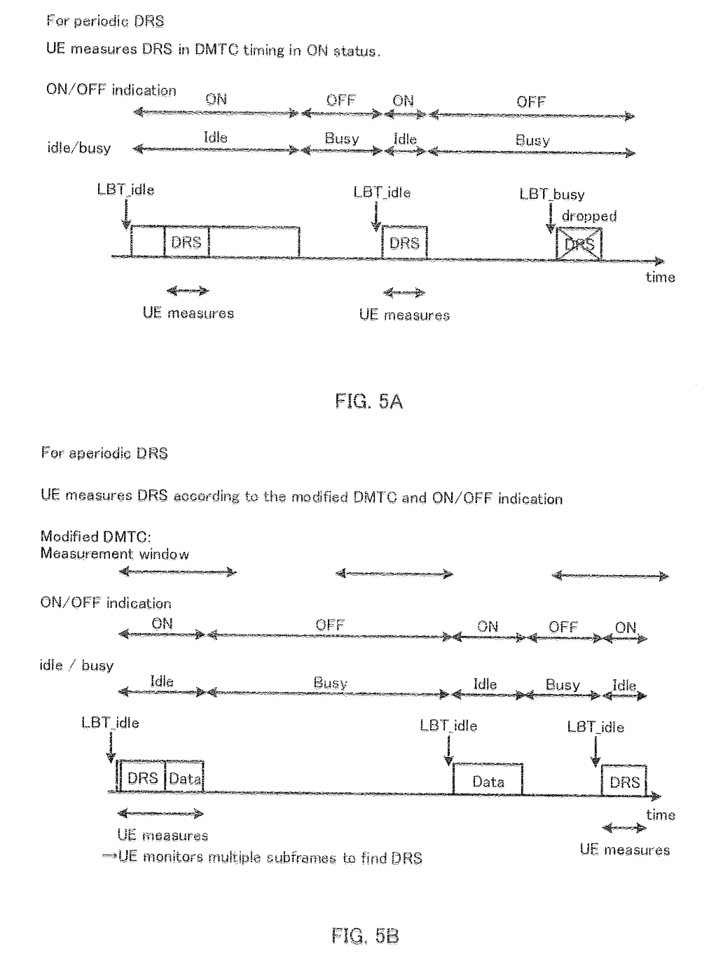

Next, the operation assuming the case where the method in which a user terminal applies blind detection to the ON/OFF status of a secondary cell (unlicensed carrier) will be described with reference to FIG. 5. As shown in FIG. 5A, when DRSs are transmitted periodically in a secondary cell, periodic DRS measurement timings are reported to a user terminal by means of DMTC, and the user terminal learns the ON/OFF status of the secondary cell by blind detection of reference signals (for example, the CRS). The user terminal may operate to measure the DRSs at periodic measurement timings when the secondary cell is in ON status—that is, when reference signals are detected—and not measure the DRSs when the secondary cell is in OFF status—that is, when no reference signals are detected.

In this case, although a DRS is dropped when the channel is in busy status, the secondary cell is in OFF status when the channel is in busy status, and therefore the user terminal does not operate to conduct wrong DRS measurements where no DRSs are transmitted. Also, in the blind detection by the user terminal, the ON/OFF status of the secondary cell is determined based on whether or not there are reference signals. Since whether or not data can be actually transmitted in the present state is judged based on whether or not reference signals are present, DRSs are not transmitted while the secondary cell is in OFF status and reference signals cannot be detected. Consequently, it is possible to avoid performing measurements when DRSs are not transmitted and/or missing DRS measurements, and allow the user terminal to measure periodic DRSs adequately, so that the reliability of DRS measurements is not damaged.

Meanwhile, assume the case where, as shown in FIG. 5B, when DRSs are transmitted aperiodically in the secondary cell, a measurement window that is longer than the DRS transmission period is configured in the user terminal, and the user terminal learns the ON/OFF status of the secondary cell by performing blind detection of reference signals. The user terminal monitors the measurement window when the secondary cell is in ON status, and measures DRSs, which are transmitted somewhere in the measurement window. Also, the user terminal does not monitor the measurement window when the secondary cell is in OFF status, and does not measure the DRSs that are transmitted in this measurement window.

As described above, since DRSs are not transmitted while the secondary cell is in OFF status, it is possible to avoid missing DRS measurements. Also, since the user terminal monitors the period where the measurement window and the ON status of the secondary cell overlap, the load of the user terminal can be reduced compared to the case of monitoring the whole of the measurement window (see FIG. 3B). However, even in this case, the user terminal has to monitor DRSs longer that the period DRSs are actually transmitted, and therefore the user terminal' power consumption is not reduced to a sufficient level.

In this way, even when the ON/OFF status of the secondary cell is reported to the user terminal by using L1 signaling, problems such as missing DRS measurements and the load of the user terminal arise. Also, even when the ON/OFF status of the secondary cell is detected by blind detection in the user terminal, there are problems such as the user terminal's load. So, the present inventors have focused on the fact that DRSs are transmitted based on LBT results in an unlicensed carrier, and come up with the idea of allowing a user terminal to receive the DRSs adequately by reporting the result of LBT and the DRS measurement timings to the user terminal. Now, the radio communication method according to the present invention will be described below.

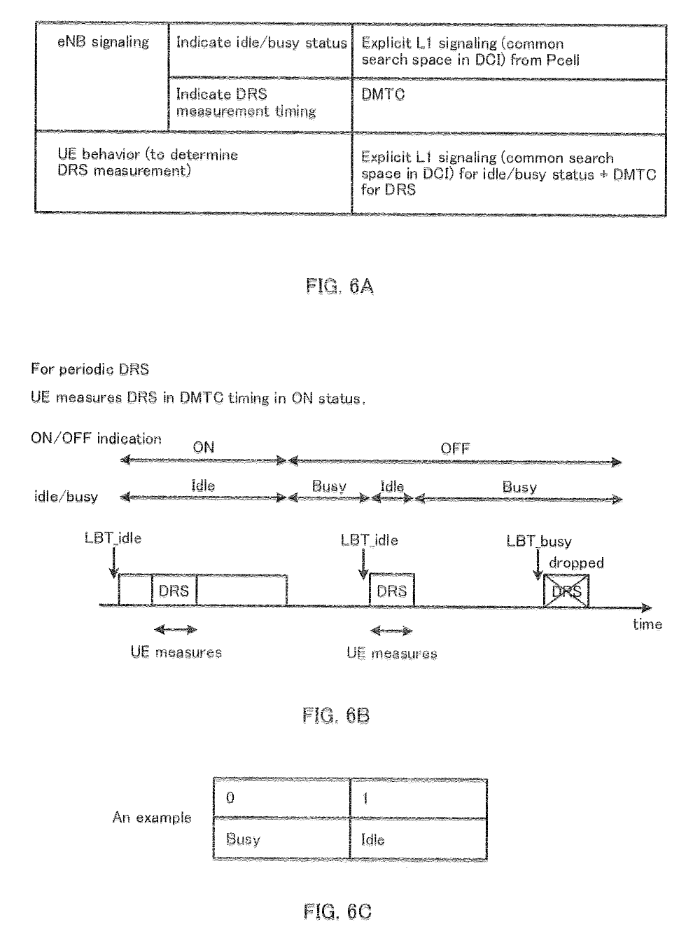

FIG. 6 provide diagrams to explain the first radio communication method of the present invention. The first radio communication method is the method for use when DRSs are transmitted periodically in a secondary cell (unlicensed carrier). As shown in FIG. 6A, with the first radio communication method, the results of LBT in an unlicensed carrier are reported to a user terminal by using the primary cell's L1 signaling, and the periodic DRS measurement timings are reported to the user terminal by means of DMTC, in higher layer signaling. The user terminal measures the DRS when the user terminal arrives at a periodic DRS measurement timing and is informed through L1 signaling that the unlicensed carrier's channel is in idle status (LBT-idle), but does not measure the DRS if the channel is in busy status (LBT-busy), even at a periodic DRS measurement timing.

As shown in FIG. 6B, when the channel is in busy status, the DRS is dropped, but the channel's busy status is reported to the user terminal, and therefore the user terminal does not operate to perform wrong DRS measurements where DRSs are not transmitted. Also, although cases occur where DRSs are transmitted even while the secondary cell assumes OFF status, the channel is idle when DRSs are transmitted. A report is sent to the user terminal, as an LBT result, when the channel is idle, so that it is possible to make the user terminal catch the DRSs that are transmitted while the secondary cell is in OFF status. Consequently, it is possible to allow the user terminal to adequately measure the DRSs that are transmitted in the secondary cell, and improve the reliability of measurements.

In this L1 signaling, downlink control information (DCI) to include the LBT results is transmitted in the common search space of the primary cell's downlink control channels (the PDCCH (Physical Downlink Control CHannel) and the ePDCCH (enhanced Physical Downlink Control CHannel). By using the common search space, it is possible let all the user terminals that support LAA in the cell know the results of LBT in the unlicensed carrier. By this means, DRS measurement reports can be acquired not only from the user terminals that are being subject to scheduling, but also from user terminals that might be subject to scheduling later.

A shown in FIG. 6C, in DCI, the result of LBT in a subframe may be configured in one bit. For example, when LBT yields “0,” this may represent busy status, and “1” may represent idle status. The LBT result may be applied to the subframe that is used to transmit the DCI, or may be applied to the subframe several ms after that subframe. Also, in DCI, the LBT results of a plurality of subframes may be configured in one bit as in DMTC, or the LBT results for N subframes may be configured in N bits. It is equally possible to report a plurality of unlicensed carriers' LBT results by using a plurality of bits in a DCI format. For example, it is possible to assign one bit to every one unlicensed carrier and configure the LBT result in association with its CC index.

In this case, existing DCI formats such as DCI formats 0/1A/1C/3/3A and so on may be used. It is possible to allow the user terminal to interpret these existing formats as DCI for DRS measurements by using dedicated RNTIs (Radio Network Temporary Identifiers). Also, by using existing DCI formats, the load of blind demodulation in the user terminal can be reduced. For example, the payload size of DCI format 1C is minimum 15 bits, so that the overhead can be reduced by using DCI format 1C. When an existing DCI format is used, 0 may be configured in the bits that are left after the LBT result is assigned, and in the last bit. Note that the dedicated RNTIs may also be referred to as “LAA-RNTIs” (Licensed Assisted-Access Network Radio Temporary Identifiers).

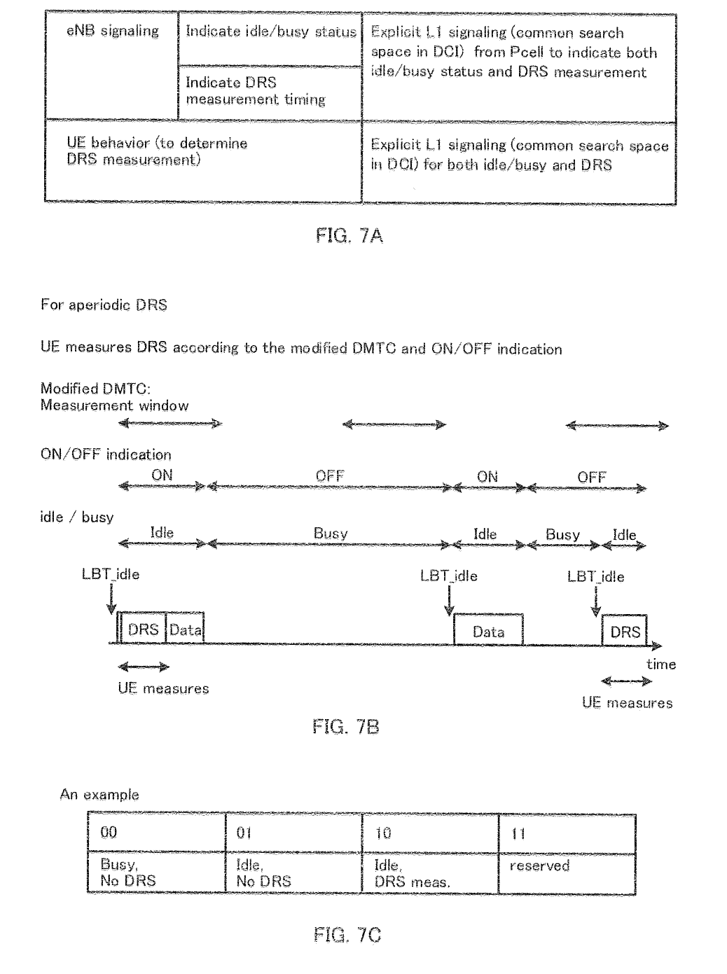

FIG. 7 provide diagrams to explain a second radio communication method of the present invention. The second radio communication method is a method for use when DRSs are transmitted aperiodically in a secondary cell (unlicensed carrier). As shown in FIG. 7A, with the second radio communication method, the results of LBT in an unlicensed carrier and aperiodic DRS measurement timings are reported to a user terminal by using the primary cell's L1 signaling. The user terminal measures the DRS when the user terminal arrives at a timing where the DRS can be measured and is informed that the unlicensed carrier's channel is in idle status (LBT-idle), and does not measure the DRS when the channel is in busy status (LBT-busy) or at timings other than DRS measurement timings.

As shown in FIG. 7B, although aperiodic DRSs are transmitted somewhere in the predetermined period that is indicated by the measurement window, since the timings to measure DRSs are reported to the user terminal, the user terminal has to measure DRSs only during the period DRSs are transmitted. Consequently, the user terminal does not have to monitor the whole of the measurement window, so that the load of the user terminal can be reduced. Also, although there are cases where the secondary cell is in OFF status but DRSs are nevertheless transmitted, the channel is idle when DRSs are transmitted. The idle status of the channel is reported to the user terminal as an LBT result, which enables the user terminal to catch the DRSs that are transmitted while the secondary cell is in OFF status. Consequently, it is possible to allow the user terminal to adequately measure the DRSs that are transmitted in the secondary cell, and improve the reliability of measurements.

In this L1 signaling, downlink control information (DCI) to include the LBT results and the measurement timings is transmitted in the common search space of the primary cell's downlink control channels (the PDCCH and the ePDCCH). By using the common search space, it is possible let all the user terminals that support LAA in the cell know the results of LBT and the timings to measure DRSs in the unlicensed carrier. By this means, DRS measurement reports can be acquired not only from the user terminals that are being subject to scheduling, but also from user terminals that might be subject to scheduling later.

A shown in FIG. 7C, in DCI, the combination of the LBT result and the DRS measurement timing for a subframe may be configured in two bits. For example, the combination “00” may indicate that the channel is in busy status and the DRS is not measured, “01” may indicate that the channel is in idle status and the DRS is not measured, and “10” may indicate that the channel is in idle status and the DRS is measured. Also, “11” may be reserved for a spare. This combination may be applied to the subframe that is used to transmit the DCI, or may be applied to the subframe several ms after that subframe.

In DCI, the combination of the LBT results and the transmission timings for a plurality of subframes may be configured in two bits, or the combination of the LBT results and transmission timings for N subframes may be configured in 2N bits. It is equally possible to report a plurality of unlicensed carriers' LBT results and DRS transmission timings by using a plurality of bits in a DCI format. For example, it is possible to assign two bits to every one unlicensed carrier and configure the combination of the LBT result and the DRS measurement timing in association with its CC index.

Similar to the first radio communication method, existing DCI formats such as DCI formats 0/1A/1C/3/3A and so on may be used. It is possible to allow the user terminal to interpret these existing formats as DCI for DRS measurements by using dedicated RNTIs. Since the payload size of DCI format 1C is minimum 15 bits, the overhead can be reduced by using DCI format 1C. When an existing DCI format is used, 0 may be configured in the bits that are left after the LBT result is assigned, and in the last bit.

Note that the timings to measure DRSs do not necessarily depend on whether or not DRS measurement takes place in each subframe, and can be configured in any way as long as DRS measurement timings can be indicated. Also, the structure to combine and report the LBT result and the DRS transmission timing is by no means limiting, and can be reported separately.

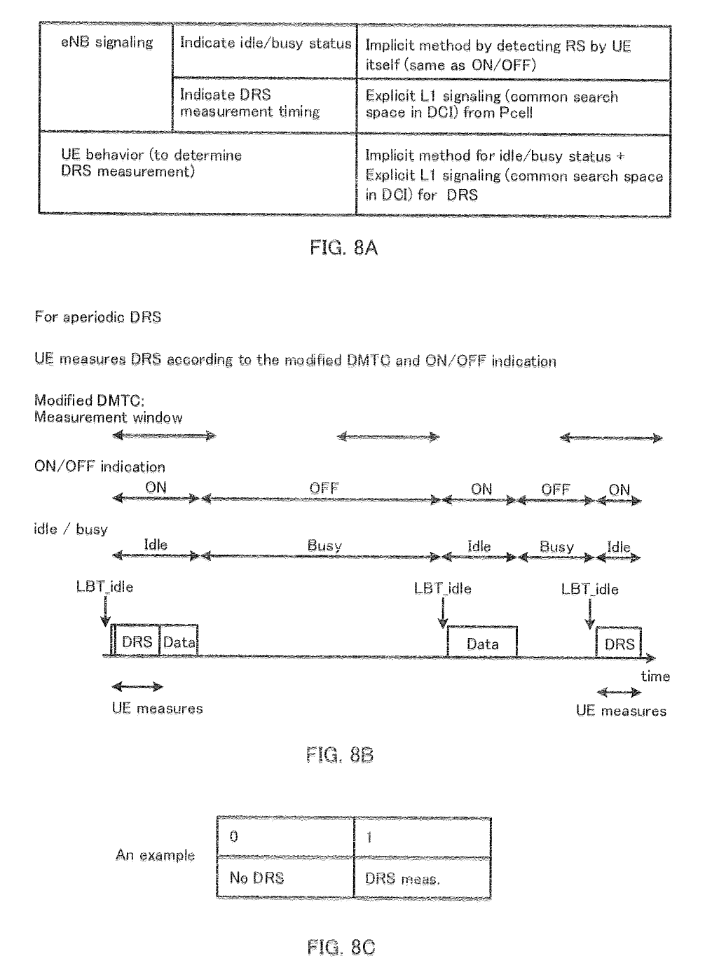

FIG. 8 provide diagrams to explain a third radio communication method of the present invention. The third radio communication method is a method for use when DRSs are transmitted aperiodically in a secondary cell (unlicensed carrier). As shown in FIG. 8A, with the third radio communication method, aperiodic DRS measurement timings are reported to a user terminal by using the primary cell's L1 signaling. Also, the user terminal learns whether or not the secondary cell's channel is in idle status/busy status—that is, LBT results—by performing blind detection of reference signals (for example, the CRS). This channel's LBT results match the ON/OFF status of the secondary cell. The user terminal measures the DRS when a DRS measurement timing is reported, and does not measure the DRS when there is no report.

As shown in FIG. 8B, although aperiodic DRSs are transmitted somewhere in the predetermined period that is indicated by the measurement window, since the timings to measure DRSs are reported to the user terminal, the user terminal has to measure DRSs only during the period DRSs are transmitted. Consequently, the user terminal does not have to monitor the whole of the measurement window, so that the load of the user terminal can be reduced. Since DRSs are not transmitted unless the unlicensed carrier's channel is idle and the idle status of the channel is detected in the user terminal, it is possible to avoid missing DRS measurements. Consequently, it is possible to allow the user terminal to adequately measure the DRSs that are transmitted in the unlicensed carrier and improve the reliability of measurements.

In this L1 signaling, downlink control information (DCI) to include the measurement timings is transmitted in the common search space of the primary cell's downlink control channels (the PDCCH and the ePDCCH). By using the common search space, it is possible let all the user terminals that support LAA in the cell know the timings to measure DRSs. By this means, DRS measurement reports can be acquired not only from the user terminals that are being subject to scheduling, but also from user terminals that might be subject to scheduling later.

A shown in FIG. 8C, in DCI, the DRS measurement timing for a subframe may be configured in one bit. For example, when the DRS measurement timing is “0,” this may indicate that the DRS is not measured, and “1” may indicate that the DRS is measured. The DRS measurement timing may be applied to the subframe that is used to transmit the DCI, or may be applied to the subframe several ms after that subframe. Also, in DCI, the DRS transmission timings for a plurality of subframes may be configured in one bit, or the DRS transmission timings for N subframes may be configured in N bits. It is equally possible to report a plurality of unlicensed carriers' DRS transmission timings by using a plurality of bits in a DCI format. For example, it is possible to assign one bit to every one unlicensed carrier and configure the DRS transmission timing in association with its CC index.

Similar to the first radio communication method, existing DCI formats such as DCI formats 0/1A/1C/3/3A and so on may be used. It is possible to allow the user terminal to interpret these existing formats as DCI for DRS measurements by using dedicated RNTIs. Also, since the payload size of DCI format 1C is minimum 15 bits, the overhead can be reduced by using DCI format 1C. When an existing DCI format is used, 0 may be configured in the bits that are left after the DRS transmission timing is assigned, and in the last bit. Also, the third radio communication method is effective not only when DRSs are transmitted aperiodically, but also when DRSs are transmitted periodically.

Note that, with the first to the third radio communication method, assist information for DRS measurements is reported in addition to the above-described LBT results, DRS measurement timings and so on. The assist information includes information that is required in DRS detection, and may include, for example, the state of synchronization between small cells and macro cells, a list of small cell identifiers (IDs), the transmission frequency, the transmission timing (for example, the DRS measurement period, the DRS cycle, etc.), the transmission power, the number of antenna ports and the signal configuration of the DRS, and so on. Also, the assist information may be transmitted in higher layer signaling (for example, RRC signaling), or may be transmitted in broadcast information. Also, the DRS measurement period (DRS occasion) may be reported to user terminals using one of DMTC, L1 signaling, higher layer signaling and broadcast signals, or may be configured in advance between user terminals and radio base stations.

Also, with the first to the third radio communication method, when DCI is transmitted in the primary cell after LBT, the DRS is transmitted in a secondary cell. Although DCI and the DRS may be transmitted at the same subframe timing, considering that delays are produced if a user terminal demodulates DCI and then measures the DRS, it may be possible to transmit the DRS over a plurality of subframes. If the DRS is transmitted in a plurality of subframes, it is possible to prevent the channel from being occupied by other systems while delays are produced. In how many subframes the DRS is transmitted after DCI is reported may be configured in higher layer signaling, or may be configured in advance between user terminals and radio base stations.

The DRS in this case needs not be structured to place the PSS/SSS in the top subframe as shown in FIG. 2, and may be configured to place the PSS/SSS in a later subframe (the second or later subframe). By this means, even when delays are produced before the DRS is measured and the top subframe's sight is lost, it is still possible to detect the PSS/SSS placed in a subsequent subframe. Also, since CRSs are transmitted in all subframes during the DRS period, it is possible to measure after PSS/SSS synchronization is established. In this way, by providing one or more subframe before the subframe in which the PSS/SSS are transmitted, it is possible to solve the problem with delayed DRS measurements.

Also, a user terminal generates a measurement report by combining and averaging DRS measurement results. In this case, a measurement report of, for example, the RSRP (Reference Signal Received Power) is prepared by combining and averaging the measurement results upon DRS measurement timings. A measurement report that relates to interference cancellation, such as one of the RSSI (Received Signal Strength Indicator), may be prepared by including measurement results that are acquired at timings apart from the DRS measurement timings, so that the interference when the channel is in busy status is mirrored. When no DRS is reported to the user terminal, it is possible to make the user terminal interpret this as an indication of the fact that the channel is in busy status.

Furthermore, when there is no specification as to whether the subframe in which a DRS is transmitted is directed to a UL or a DL subframe, the UL terminal may interpret that the subframe is a DL subframe when the DRS measurement timing is reported, and measure the DRS. In this case, since DRSs are not transmitted in UL subframes, even after the DRS measurement timing is reported, DRS measurement needs not be conducted if a subframe is identified as a UL subframe. For example, when a UL subframe is mixed in among a plurality of subframes, even if DRS measurement timings are reported, it is still possible to allow the user terminal to measure only the DRSs of DL subframes.

Also, although the present embodiment has been described using examples in which the licensed carrier is the primary cell and the unlicensed carrier is a secondary cell, this structure is by no means limiting. The type of the primary cell carrier (the first carrier) is not particularly limited, and the secondary cell carrier (second carrier) has only to have LBT functions. For example, the carrier of a secondary cell needs not be an unlicensed carrier, and can be a carrier that includes a band shared by a plurality of user terminals.

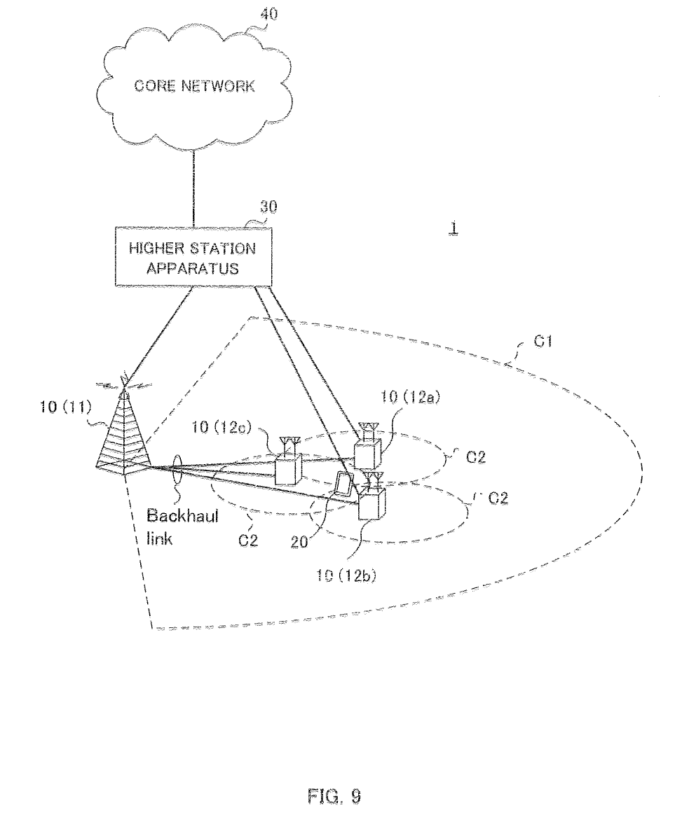

Now, the radio communication system according to the present embodiment will be described in detail. FIG. 9 is a diagram to show a schematic structure of the radio communication system according to the present embodiment. In this radio communication system, the first to the third radio communication method described above are employed. Note that the above first to third radio communication methods may be applied individually or may be applied in combination.

Note that the radio communication system 1 shown in FIG. 9 is a system to incorporate, for example, an LTE system, super 3G, an LTE-A system and so on. The radio communication system 1 can adopt carrier aggregation (CA) to group a plurality of fundamental frequency blocks (component carriers) into one, where the LTE system bandwidth constitutes one unit, and/or adopt dual connectivity (DC). Also, the radio communication system 1 has a radio base station (for example, an LTE-U base station) that is capable of using unlicensed carriers. Note that the radio communication system 1 may be referred to as “IMT-Advanced,” or may be referred to as “4G,” “5G,” “FRA” (Future Radio Access) and so on.

The radio communication system 1 includes a radio base station 11 that forms a macro cell C1, and radio base stations 12a to 12c that form small cells C2, which are placed within the macro cell C1 and which are narrower than the macro cell C1. Also, user terminals 20 are placed in the macro cell C1 and in each small cell C2. For example, a mode may be possible in which the licensed carrier of the macro cell C1 is used as the primary cell, and the unlicensed carriers of the small cells C2 are used as secondary cells. Also, a mode may be possible in which a given mall cell's licensed carrier is used as the primary cell, and the rest of the small cells' unlicensed carriers are used as secondary cells.

The user terminals 20 can connect with both the radio base station 11 and the radio base stations 12. The user terminals 20 may use the macro cell C1 and the small cells C2, which use different frequencies, at the same time, by means of CA or DC. For example, it is possible to transmit assist information (for example, the DL signal configuration) related to a radio base station 12 (which is, for example, an LTE-U base station) that uses an unlicensed carrier, from the radio base station 11 using a licensed carrier to the user terminals 20. Also, a structure may be employed here in which, when CA is used between a licensed carrier and an unlicensed carrier, one radio base station (for example, the radio base station 11) controls the scheduling of the licensed carrier and the unlicensed carrier.

Between the user terminals 20 and the radio base station 11, communication is carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Note that the frequency bands for use in each radio base station are by no means limited to these. Between the radio base station 11 and the radio base stations 12 (or between two radio base stations 12), wire connection (optical fiber, the X2 interface, etc.) or wireless connection may be established.

The radio base station 11 and the radio base stations 12 are each connected with a higher station apparatus 30, and are connected with a core network 40 via the higher station apparatus 30. Note that the higher station apparatus 30 may be, for example, an access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB” (eNodeB), a “transmitting/receiving point” and so on. Also, the radio base stations 12 are radio base stations having local coverages, and may be referred to as “small base stations,” “micro base stations,” “pico base stations,” “femto base stations,” “HeNBs” (home eNodeBs), “RRHs” (Remote Radio Heads), “transmitting/receiving points” and so on. Hereinafter the radio base stations 11 and 12 will be collectively referred to as “radio base stations 10,” unless specified otherwise. Also, it is preferable to configure radio base stations 10 that use the same unlicensed carrier on a shared basis to be synchronized in time.

The user terminals 20 are terminals to support various communication schemes such as LTE, LTE-A and so on, and may be either mobile communication terminals or stationary communication terminals.

In the radio communication system 1, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency band into a plurality of narrow frequency bands (subcarriers) and mapping data to each subcarrier. SC-FDMA is a single-carrier communication scheme to mitigate interference between terminals by dividing the system band into bands formed with one or continuous resource blocks per terminal, and allowing a plurality of terminals to use mutually different bands. Note that the uplink and downlink radio access schemes are by no means limited to the combination of these.

In the radio communication system 1, a downlink shared channel (PDSCH: Physical Downlink Shared CHannel), which is used by each user terminal 20 on a shared basis, a broadcast channel (PBCH: Physical Broadcast CHannel), downlink L1/L2 control channels and so on are used as downlink channels. User data, higher layer control information and predetermined SIBs (System Information Blocks) are communicated in the PDSCH. Also, synchronization signals, MIBs (Master Information Blocks) and so on are communicated by the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI) including PDSCH and PUSCH scheduling information is communicated by the PDCCH. The number of OFDM symbols to use for the PDCCH is communicated by the PCFICH. HARQ delivery acknowledgement signals (ACKs/NACKs) in response to the PUSCH are communicated by the PHICH. The EPDCCH may be frequency-division-multiplexed with the PDSCH (downlink shared data channel) and used to communicate DCI and so on, like the PDCCH.

In the radio communication system 1, an uplink shared channel (PUSCH: Physical Uplink Shared CHannel), which is used by each user terminal 20 on a shared basis, an uplink control channel (PUCCH: Physical Uplink Control CHannel), a random access channel (PRACH: Physical Random Access CHannel) and so on are used as uplink channels. User data and higher layer control information are communicated by the PUSCH. Also, downlink radio quality information (CQI: Channel Quality Indicator), delivery acknowledgement signals and so on are communicated by the PUCCH. By means of the PRACH, random access preambles for establishing connections with cells are communicated.

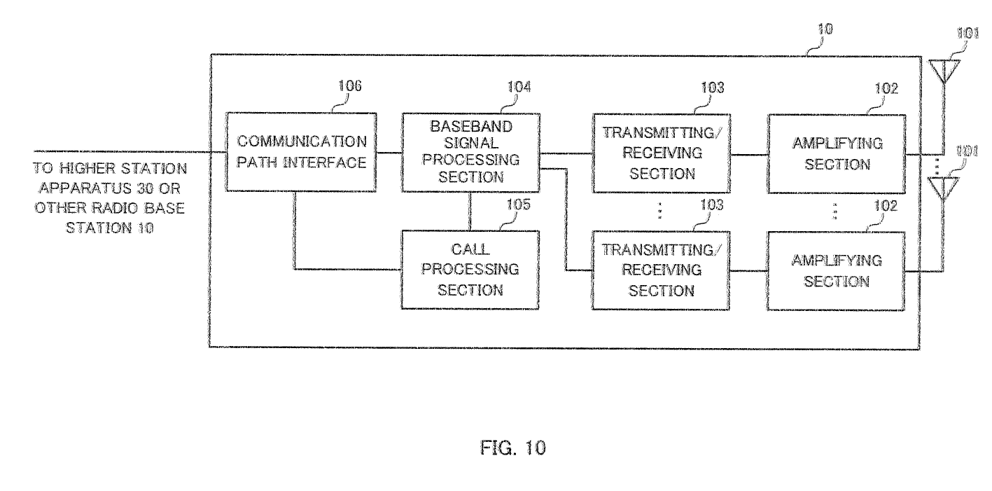

FIG. 10 is a diagram to show an example of an overall structure of a radio base station according to the present embodiment. The radio base station 10 has a plurality of transmitting/receiving antennas 101 for MIMO communication, amplifying sections 102, transmitting/receiving sections 103, a baseband signal processing section 104, a call processing section 105 and a communication path interface 106. Note that the transmitting/receiving sections 103 may be comprised of transmitting sections and receiving sections. Also, although multiple transmitting/receiving antennas 101 are provided here, it is also possible to provide only one.

User data to be transmitted from the radio base station 10 to a user terminal 20 on the downlink is input from the higher station apparatus 30, into the baseband signal processing section 104, via the transmission path interface 106.

In the baseband signal processing section 104, the user data is subjected to a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Also, the baseband signal processing section 104 reports, to the user terminal 20, control information for allowing communication in the cell (system information), through higher layer signaling (for example, RRC signaling, broadcast signals and so on). The information for allowing communication in the cell includes, for example, the system bandwidth on the uplink, the system bandwidth on the downlink, and so on. Also, assist information related to communication in an unlicensed carrier may be transmitted from a radio base station (for example, the radio base station 11) to the user terminal 20 by using a licensed carrier.

Each transmitting/receiving section 103 converts baseband signals that are pre-coded and output from the baseband signal processing section 104 on a per antenna basis, into a radio frequency band. The radio frequency signals having been subjected to frequency conversion in the transmitting/receiving sections 103 are amplified in the amplifying sections 102, and transmitted from the transmitting/receiving antennas 101. For the transmitting/receiving sections 103, transmitters/receivers, transmitting/receiving circuits or transmitting/receiving devices that can be described based on common understanding of the technical field to which the present invention pertains can be used.

Meanwhile, as for uplink signals, radio frequency signals that are received in the transmitting/receiving antennas 101 are each amplified in the amplifying sections 102. Each transmitting/receiving section 103 receives uplink signals amplified in the amplifying sections 102. The received signals are converted into the baseband signal through frequency conversion in the transmitting/receiving sections 103, and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base stations 10 and manages the radio resources.

The communication path interface section 106 transmits and receives signals to and from the higher station apparatus 30 via a predetermined interface. Also, the communication path interface 106 may transmit and receive signals (backhaul signaling) to and from other radio base stations 10 (for example, neighboring radio base stations) via an inter-base station interface (for example, optical fiber, the X2 interface, etc.). For example, the communication path interface 106 may transmit and receive information about the subframe configuration that relates to LBT, to and from other radio base station 10.

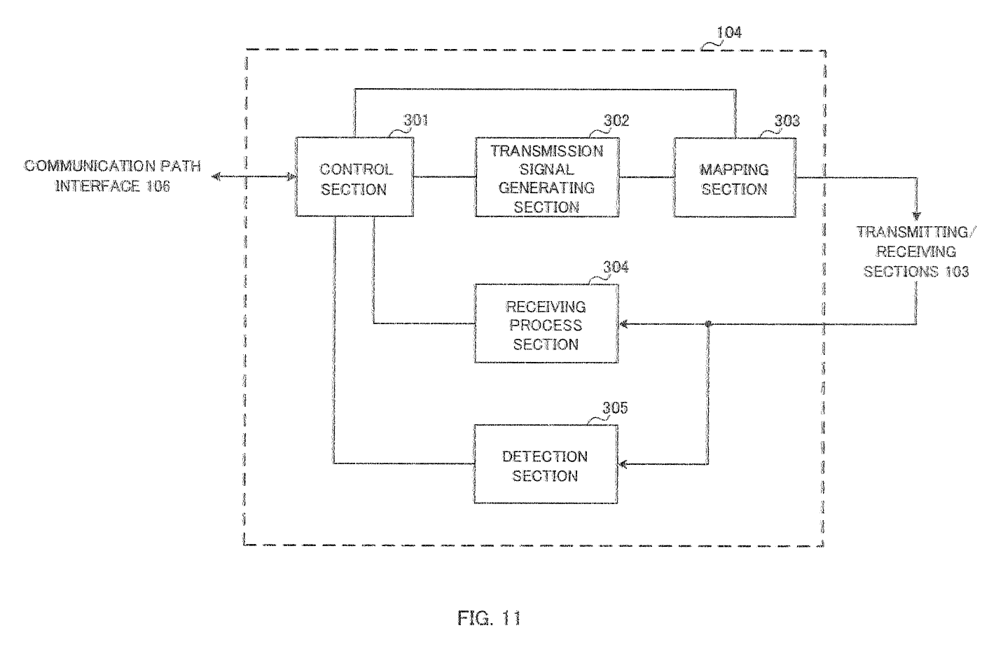

FIG. 11 is a diagram to show an example of a functional structure of a radio base station according to the present embodiment. Note that, although FIG. 11 primarily shows functional blocks that pertain to characteristic parts of the present embodiment, the radio base station 11 has other functional blocks that are necessary for radio communication as well. As shown in FIG. 11, the baseband signal processing section 104 provided in the radio base station 10 has a control section (scheduler) 301, a transmission signal generating section 302, a mapping section 303 and a receiving process section 304.

The control section (scheduler) 301 controls the scheduling of (for example, allocates resources to) downlink data signals that are transmitted in the PDSCH and downlink control signals that are communicated in the PDCCH and/or the enhanced PDCCH (EPDCCH). Also, the control section 301 controls the scheduling of downlink reference signals such as system information, synchronization signals, the CRS (Cell-specific Reference Signal), the CSI-RS (Channel State Information Reference Signal) and so on. Also, the control section 301 controls the scheduling of uplink reference signals, uplink data signals that are transmitted in the PUSCH, uplink control signals that are transmitted in the PUCCH and/or the PUSCH, RA preambles that are transmitted in the PRACH, and so on.

The control section 301 controls the transmission signal generating section 302 and the mapping section 303 to transmit downlink signals in an unlicensed carrier based on the results of LBT in the unlicensed carrier. For example, when an LBT result that is yielded indicates idle status, the control section 301 controls the transmission signal generating section 302 and the mapping section 303 to transmit downlink data. Also, the control section 301 may control DRSs to be transmitted periodically in an unlicensed carrier (the first radio communication method), or control DRSs to be transmitted aperiodically in an unlicensed carrier (the second and third radio communication methods).

The control section 301 functions as a determining section that determines the timings to measure DRSs. When DRSs are transmitted periodically, DRS measurement timings are determined based on DMTC. When DRSs are transmitted aperiodically, DRS measurement timings are determined somewhere in measurement windows that are configured longer than the period DRSs are transmitted. Also, the control section 301 controls the LBT results and/or the DRS measurement timings in an unlicensed carrier to be included in DCI. For the control section 301, a controller, a control circuit or a control device that can be described based on common understanding of the technical field to which the present invention pertains can be used.

The transmission signal generating section 302 generates DL signals based on commands from the control section 301 and outputs these signals to the mapping section 303. For example, the transmission signal generating section 302 generates DL assignments, which report downlink signal allocation information, and UL grants, which report uplink signal allocation information, based on commands from the control section 301. Also, the downlink data signals are subjected to a coding process and a modulation process, based on coding rates and modulation schemes that are determined based on channel state information (CSI) from each user terminal 20 and so on.

Also, the transmission signal generating section 302 generates DCI that includes the LBT results and/or the DRS measurement timings in an unlicensed carrier. For example, the transmission signal generating section 302 may generate DCI that includes the LBT result of a subframe (the first radio communication method). This LBT result may be generated as a one-bit signal that indicates the idle status/busy status of the channel. The transmission signal generating section 302 may generate DCI that includes the LBT result for a subframe and the DRS measurement timing for the subframe (the second radio communication method). The LBT result and the DRS measurement timing may be generated as a two-bit signal that indicates, in combination, whether the channel is in idle status or in busy status, and whether or not DRS measurement is executed. The transmission signal generating section 302 may generate DCI that includes the measurement timing for a subframe (the third radio communication method). This DRS measurement timing may be generated as a one-bit signal that indicates whether or not DRS measurement is carried out. The pieces of DCI for unlicensed carriers are generated by using new RNTIs that are dedicated for use in unlicensed carriers.

Based on commands from the control section 301, the transmission signal generating section 302 generates DMTC that indicates periodic DRS measurement timings (the first radio communication method), assist information that relates to communication in unlicensed carriers and so on. Furthermore, based on commands from the control section 301, the transmission signal generating section 302 generates DRSs to transmit in unlicensed carriers. As DRSs, combinations of synchronization signals (PSS/SSS) and reference signals (CRS/CSI-RS) are generated. For the transmission signal generating section 302, a signal generator, a signal generating circuit or a signal generating device that can be described based on common understanding of the technical field to which the present invention pertains can be used.

The mapping section 303 maps the downlink signals generated in the transmission signal generating section 302 to radio resources based on commands from the control section 301, and outputs these to the transmitting/receiving sections 103. In this case, the mapping section 303 maps DCI that includes the LBT results and/or the DRS measurement timings in an unlicensed carrier in the common search space of downlink control channels. By this means, it is possible to let all the user terminals in the cell know the DRS transmission timings that take the LBT results into consideration. It is also possible to map a DRS over a plurality of subframes, from a subframe in which DCI is reported, taking into account the delay from the DCI demodulation to the DRS measurement in a user terminal, and, in this case, the PSS/SSS may be mapped to the second and later subframes. For the mapping section 303, mapper, a mapping circuit or a mapping device that can be described based on common understanding of the technical field to which the present invention pertains can be used.

The receiving process section 304 performs receiving processes (for example, demapping, demodulation, decoding and so on) of UL signals (for example, delivery acknowledgement signals (HARQ-ACKs), data signals that are transmitted in the PUSCH, and so on) transmitted from the user terminals. For the receiving process section 304, a signal processor/measurer, a signal processing/measurement circuit or a signal processing/measurement device that can be described based on common understanding of the technical field to which the present invention pertains can be used.

The detection section 305 performs receiving processes based on commands from the control section 301, and executes LBT in an unlicensed carrier. When the unlicensed carrier's received power measured upon LBT is equal to or lower than a threshold, an LBT result to indicate that the channel is in idle status is detected. When the unlicensed carrier's received power measured upon LBT is greater than the threshold, an LBT result to indicate that the channel is in busy status is detected. The detection section 305 outputs the LBT result to the control section 301. The detection section 305 may execute LBT periodically, or execute LBT at arbitrary timings based on whether or not there is data to transmit in the unlicensed carrier. For the transmitting/receiving sections 203, transmitters/receivers, transmitting/receiving circuits or transmitting/receiving devices that can be described based on common understanding of the technical field to which the present invention pertains can be used.

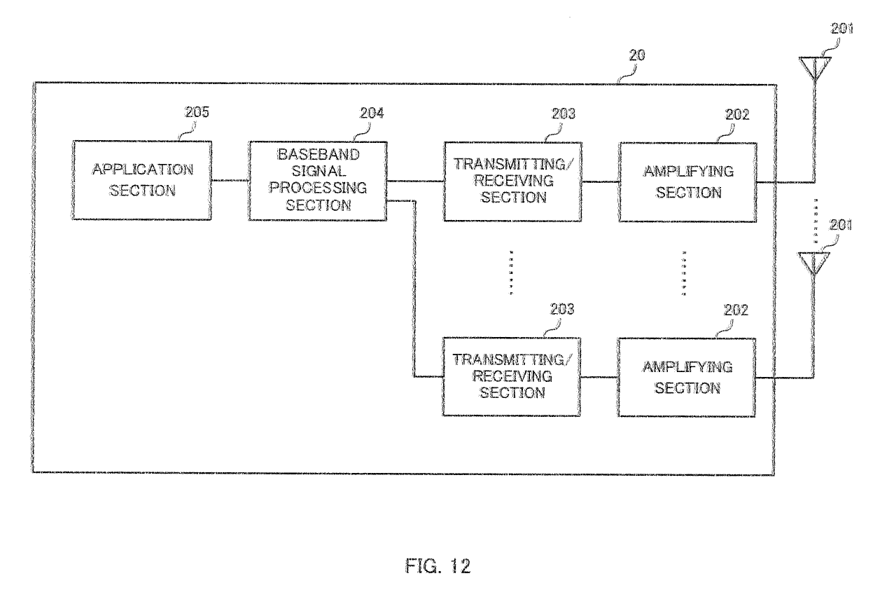

FIG. 12 is a diagram to show an example of an overall structure of a user terminal according to the present embodiment. A user terminal 20 has a plurality of transmitting/receiving antennas 201 for MIMO communication, amplifying sections 202, transmitting/receiving sections 203, a baseband signal processing section 204 and an application section 205. Note that the transmitting/receiving sections 203 may be comprised of transmitting sections and receiving sections. Also, although multiple transmitting/receiving antennas 201 are provided here, it is also possible to provide only one.

Radio frequency signals that are received in a plurality of transmitting/receiving antennas 201 are each amplified in the amplifying sections 202. Each transmitting/receiving section 203 receives the downlink signals amplified in the amplifying sections 202. The received signals are subjected to frequency conversion and converted into the baseband signal in the transmitting/receiving sections 203, and output to the baseband signal processing section 204. For the transmitting/receiving sections 203, transmitters/receivers, transmitting/receiving circuits or transmitting/receiving devices that can be described based on common understanding of the technical field to which the present invention pertains can be used.

In the baseband signal processing section 204, the baseband signals that are input are subjected to an FFT process, error correction decoding, a retransmission control receiving process, and so on. Downlink user data is forwarded to the application section 205. The application section 205 performs processes related to higher layers above the physical layer and the MAC layer. Furthermore, in the downlink data, broadcast information is also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, pre-coding, a discrete Fourier transform (DFT) process, an IFFT process and so on, and the result is forwarded to each transmitting/receiving section 203. The baseband signal that is output from the baseband signal processing section 204 is converted into a radio frequency band in the transmitting/receiving sections 203. The radio frequency signals that are subjected to frequency conversion in the transmitting/receiving sections 203 are amplified in the amplifying sections 202, and transmitted from the transmitting/receiving antennas 201.

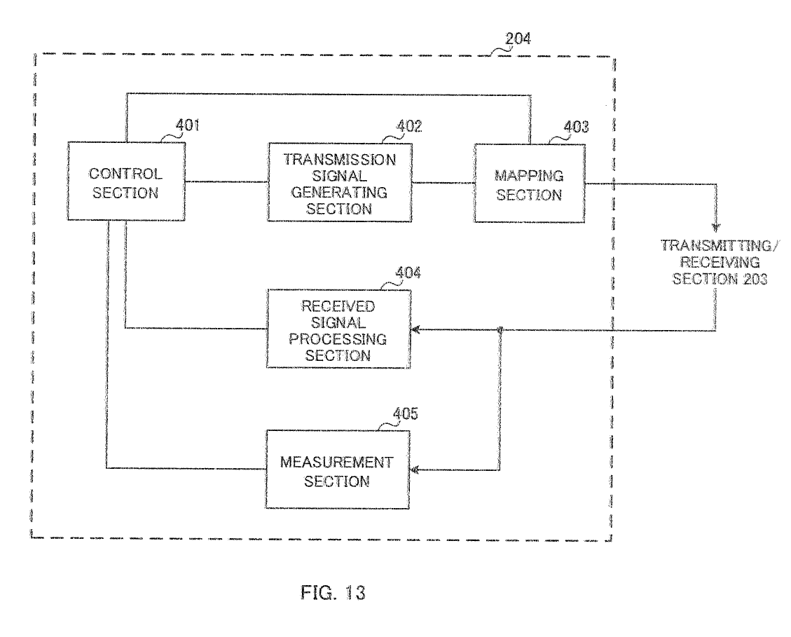

FIG. 13 is a diagram to show an example of a functional structure of a user terminal according to the present embodiment. Note that, although FIG. 13 primarily shows functional blocks that pertain to characteristic parts of the present embodiment, the user terminal 20 has other functional blocks that are necessary for radio communication as well. As shown in FIG. 13, the baseband signal processing section 204 provided in the user terminal 20 has a control section 401, a transmission signal generating section 402, a mapping section 403 and a received signal processing section 404.

The control section 401 acquires the downlink control signals (signals transmitted in the PDCCH/EPDCCH) and downlink data signals (signals transmitted in the PDSCH) transmitted from the radio base station 10, from the received signal processing section 404. When DCI (LBT results, measurement timings, etc.) and assist information for an unlicensed carrier is acquired from the received signal processing section 404, the control section 401 controls the DRS receiving process and the DRS the measurement process based on these pieces of information. Also, the control section 401 controls the generation of uplink control signals (for example, delivery acknowledgement signals (HARQ-ACKs) and so on) and uplink data signals based on the downlink control signals, the results of deciding whether or not retransmission control is necessary for the downlink data signals, and so on. To be more specific, the control section 401 controls the transmission signal generating section 402 and the mapping section 403. For the control section 401, a controller, a control circuit or a control device that can be described based on common understanding of the technical field to which the present invention pertains can be used.

The transmission signal generating section 402 generates UL signals (uplink control signals, uplink data signals, uplink reference signals and so on) based on commands from the control section 401, and outputs these signals to the mapping section 403. For example, the transmission signal generating section 402 generates uplink control signals such as delivery acknowledgement signals (HARQ-ACKs), channel state information (CSI) and so on, based on commands from the control section 401. Also, the transmission signal generating section 402 generates uplink data signals based on commands from the control section 401. For example, when a UL grant is contained in a downlink control signal reported from the radio base station 10, the control section 401 commands the transmission signal generating section 402 to generate an uplink data signal. For the transmission signal generating section 402, a signal generator, a signal generating circuit or a signal generating device that can be described based on common understanding of the technical field to which the present invention pertains can be used.

The mapping section 403 maps the uplink signals generated in the transmission signal generating section 402 to radio resources based on commands from the control section 401, and output the result to the transmitting/receiving sections 203. For the mapping section 403, a mapper, a mapping circuit or a mapping device that can be described based on common understanding of the technical field to which the present invention pertains can be used.

The received signal processing section 404 performs receiving processes (for example, demapping, demodulation, decoding and so on) of the DL signals transmitted in a licensed carrier and an unlicensed carrier (for example, downlink control signals transmitted from the radio base station, downlink data signals transmitted in the PDSCH, and so on). For example, blind detection is applied to the common search space of the downlink control channels, and the DCI for the unlicensed carrier is demodulated by using dedicated RNTIs. The LBT results and DRS measurement timings for the unlicensed carrier, included in the DCI, are output to the control section 401. The assist information, DMTC and so on that are transmitted in broadcast signals and higher layer signaling are also output to the control section 401. For the received signal processing section 404, a signal processor/measurer, a signal processing/measurement circuit or a signal processing/measurement device that can be described based on common understanding of the technical field to which the present invention pertains can be used.

The measurement section 405 measures the DRSs transmitted in an unlicensed carrier, based on commands from the control section 401. For example, when DRSs are transmitted periodically in an unlicensed carrier, the measurement section 405 may measure the DRSs at measurement timings that are configured based on the LBT results and DMTC included in the DCI (the first radio communication method). Also, when DRSs are transmitted aperiodically in an unlicensed carrier, the measurement section 405 may measure the DRSs based on the LBT results and measurement timings included in the DCI (the second radio communication method). Furthermore, when DRSs are transmitted aperiodically in an unlicensed carrier, the measurement section 405 may measure the DRSs based on the LBT results of the blind detection of the unlicensed carrier and the measurement timings included in the DCI (the third radio communication method).

Also, when there is no specification as to whether a subframe in which a DRS is transmitted is a UL subframe or a DL subframe, the measurement section 405, if the measurement timing for the DRS is received, the measurement section 405 may interpret that the subframe is a DL subframe, and measure the DRS. Also, considering the case where DRSs are transmitted in a plurality of subframe including UL subframes, the measurement section 405 does not have to measure DRSs in UL subframes even after the measurement timings in DL are reported. By this means, it is possible to allow a user terminal to measure only the DRSs in DL subframes. For the received signal processing section 404, a signal processor/measurer, a signal processing/measurement circuit or a signal processing/measurement device that can be described based on common understanding of the technical field to which the present invention pertains can be used.

The measurement results in the measurement section 405 are output to the transmission signal generating section 402 via the control section 401, and a measurement report is generated. For the measurement report, an RSRP may be generated by combining and averaging the measurement results of a plurality of DRSs measured at adequate measurement timings, an RSSI may be generated by including the measurement results acquired at timings other than DRS measurement timings.

Note that the block diagrams that have been used to describe the above embodiments show blocks in functional units. These functional blocks (components) may be implemented in arbitrary combinations of hardware and software. Also, the means for implementing each functional block is not particularly limited. That is, each functional block may be implemented with one physically-integrated device, or may be implemented by connecting two physically-separate devices via radio or via wire and using these multiple devices.

For example, part or all of the functions of radio base stations 10 and user terminals 20 may be implemented using hardware such as ASICs (Application-Specific Integrated Circuits), PLDs (Programmable Logic Devices), FPGAs (Field Programmable Gate Arrays), and so on. Also, the radio base stations 10 and user terminals 20 may be implemented with a computer device that includes a processor (CPU), a communication interface for connecting with networks, a memory and a computer-readable storage medium that holds programs. That is, the radio base station, user terminal and so on according to the embodiments of the present invention may each function as a computer that executes the processes in the radio communication method according to the present invention.

Here, the processor, the memory and/or others are connected with a bus for communicating information. Also, the computer-readable recording medium is a storage medium such as, for example, a flexible disk, an opto-magnetic disk, a ROM, an EPROM, a CD-ROM, a RAM, a hard disk and so on. Also, the programs may be transmitted from the core network 40 through, for example, electric communication channels. Also, the radio base stations 10 and user terminals 20 may include input devices such as input keys and output devices such as displays.

The functional structures of the radio base stations 10 and user terminals 20 may be implemented with the above-described hardware, may be implemented with software modules that are executed on the processor, or may be implemented with combinations of both. The processor controls the whole of the user terminals by running an operating system. Also, the processor reads programs, software modules and data from the storage medium into the memory, and executes various types of processes based on these.

Here, the programs have only to be programs that make a computer execute processing that has been described with the above embodiments. For example, the control section 401 of the user terminals 20 may be stored in the memory and implemented by a control program that operates on the processor, and other functional blocks may be implemented likewise.

Now, although the present invention has been described in detail above, it should be obvious to a person skilled in the art that the present invention is by no means limited to the embodiments described herein. For example, the above-described embodiments may be used individually or in combinations. The present invention can be implemented with various corrections and in various modifications, without departing from the spirit and scope of the present invention defined by the recitations of claims. Consequently, the description herein is only provided for the purpose of illustrating examples, and should by no means be construed to limit the present invention in any way.

The disclosure of Japanese Patent Application No. 2015-016020, filed on Jan. 29, 2015, including the specification, drawings and abstract, is incorporated herein by reference in its entirety.

1. A radio base station that allows a user terminal, which uses a first carrier as a primary cell, to detect a second carrier, where an LBT (Listen Before Talk) function is applied, as a secondary cell, the radio base station comprising:
a detection section that executes LBT in the second carrier and acquires an LBT result;
a determining section that determines a measurement timing for a measurement signal that is transmitted in the second carrier based on the LBT result; and
a transmission section that, when there are the LBT result and the measurement timing, transmits at least the measurement timing to the user terminal.

2. The radio base station according to claim 1, wherein:
the determining section determines a periodic measurement timing for the measurement signal that is transmitted periodically in the second carrier; and
the transmission section transmits the LBT result in a common search space in a downlink control channel, and transmits the periodic measurement timing in higher layer signaling.

3. The radio base station according to claim 1, wherein:
the determining section determines an aperiodic measurement timing for the measurement signal that is transmitted aperiodically in the second carrier; and
the transmission section transmits the LBT result and the aperiodic measurement timing in a common search space in the downlink control channel.

4. The radio base station according to claim 1, wherein:
the determining section determines an aperiodic measurement timing for the measurement signals that is transmitted aperiodically in the second carrier;
the transmission section transmits the aperiodic measurement timing in a common search space in the downlink control channel; and
the user terminal executes detection of a reference signal in the second carrier and acquires an LBT result.

5. The radio base station according to claim 2, wherein the transmission section transmits downlink control information, which includes LBT results and/or measurement timings for a plurality of subframes, in the common search space in the downlink control channel.

6. The radio base station according to claim 2, wherein the transmission section transmits downlink control information, which includes LBT results and/or measurement timings for a plurality of second carriers, in the common search space in the downlink control channel.

7. The radio base station according to claim 1, wherein:
the measurement signals are DRSs (Discovery Reference Signals), which include a synchronization signal and a reference signal; and
the transmission section transmits the DRSs over a plurality of subframes, and transmits the synchronization signal in a second and later subframes in the plurality of subframes.

8. A user terminal that uses a first carrier as a primary cell, and that detects a second carrier, where an LBT function is applied, as a secondary cell, the user terminal comprising:
a receiving section that, when there are an LBT result of executing LBT in the second carrier and a measurement timing for a measurement signal of the second carrier, receives at least the measurement timing from the radio base station; and
a measurement section that measures the measurement signal transmitted in the second carrier based on the LBT result, based on the LBT result and the measurement timing.

9. A radio communication method in which a radio base station allows a user terminal, which uses a first carrier as a primary cell, to detect a second carrier, where an LBT function is applied, as a secondary cell, the radio communication method comprising the steps of:
in the radio base station:
executing LBT in the second carrier and acquiring an LBT result;
determining a measurement timing for a measurement signal that is transmitted in the second carrier based on the LBT result; and
when there are the LBT result and the measurement timing, transmitting at least the measurement timing to the user terminal; and
in the user terminal:
when there are the LBT result and the measurement timing for the measurement signal, receiving at least the measurement timing from the radio base station; and
measuring the measurement signal transmitted in the second carrier based on the LBT result, based on the LBT result and the measurement timing.

10. The radio base station according to claim 4, wherein the transmission section transmits downlink control information, which includes LBT results and/or measurement timings for a plurality of subframes, in the common search space in the downlink control channel.

11. The radio base station according to claim 4, wherein the transmission section transmits downlink control information, which includes LBT results and/or measurement timings for a plurality of second carriers, in the common search space in the downlink control channel.

12. The radio base station according to claim 4, wherein:
the measurement signals are DRSs (Discovery Reference Signals), which include a synchronization signal and a reference signal; and
the transmission section transmits the DRSs over a plurality of subframes, and transmits the synchronization signal in a second and later subframes in the plurality of subframes.
